(19) United States
(12) Patent Application Publication
(10) Pub. No.: US 2009/0157655 A1
(43) Pub. Date: Jun. 18, 2009

(54) Process For Computer Supported Processing of Course Data Elements, System and Computer Program Product

(75) Inventor: Michael Berthold, Konstanz (DE)

Correspondence Address: MINTZ, LEVIN, COHN, FERRIS, GLOVSKY AND POPEO, P.C, ONE FINANCIAL CENTER, BOSTON, MA, 02111, US

(73) Assignee: UNIVERSITAT KONSTANZ, Konstanz (DE)

(21) Appl. No.: 12/087,804

(22) PCT Filed: Jan. 12, 2007
(86) PCT No.: PCT/EP2007/000265

§ 371 Date: Jan. 23, 2009

(30) Foreign Application Priority Data
Jan. 13, 2006 (DE) 10 2006 001 840.0

(51) Int. Cl. G06F 17/30

(52) U.S. Cl. 707/5; 707/E17.014

(57) ABSTRACT

In summary, the present invention concerns processes for computer supported processing of source data elements (32-40, 46-54) of a source data quantity (20) with the following steps:
Input of at least one query data element, particularly a search string,
Determination of a weighted link (42, 44, 60) of the query data element with at least one source data element (34, 38, 40) of the source data quantity (20), particularly with at least one hit string of the source data quantity (20) and
Output of the at least one source data element (34, 38, 40) corresponding to a weight (w₁₂, w₁₃, w₃₄) of the jointly weighted link (42, 44, 60) preferably of a hit likelihood of the query data element with the at least one source data element (34, 38, 40), wherein
the weight (w₁₂, w₁₃, w₃₄) of the weighted link (42, 44, and 60) is determined on the basis of at least one associative link (42, 44, and 60) as well as a further process, a system and a computer program product.

The present invention concerns a process for the computer supported processing of source data elements of a source data quantity, a system for processing source database elements from a source database and a computer program product.

Many companies and research institutions generate and process a large variety of information. This information is regularly stored in database systems, which are preferably networked with each other. Modern memory technology and the creativity of researchers largely place no limitations on the amount of the saved information. In order to support the development and research activity of employees as best possible, it is often necessary to provide the information which is scattered both within and outside a company and/or a research institution (and therefore delocalized) as completely as possible and in a simple manner, or enable access. This is particularly necessary in order to enable new knowledge as well as new methods of working. For instance all employees, particularly those working in the fields of research and development, should be provided with the results of experiments, discoveries of colleagues, publications etc. in a simple manner which provides a clear overview. Repetitions of experiments or unforeseeable failures should be avoided where possible.

For instance, unnecessary or duplicated work is to be avoided in research departments of pharmaceutical manufacturers. In order to develop or newly produce new and not yet known medications which, for instance, do not have negative side effects, a large variety of differing information which can be combined with each other is required. Developments are currently based strongly on experts with many years of experience, and hopefully, the right knowledge at the right time. The information sources which are created by experts are generally distributed across a group of companies, and in numerous cases, also via the internet. Examples of this include test protocols, patent information, scientific publications, experimental and biological information or data about metabolic routs/pathways. Furthermore, work by experts in a manner which overlaps departments could produce a very promising source of information. For instance, it is sufficiently known to create large sources of information which are founded on complex database technology.

It is a task of the invention to provide access to existing information and/or data in the most comprehensive manner which is possible, and be able to search the existing information and/or data in a simple and effective manner.

This task is solved by the process in accordance with Claim 1, the process in accordance with Claim 21, the system in accordance with Claim 22 and the computer program product in accordance with Claim 33. Preferred embodiment variants and/or forms constitute objects of the dependent claims.

In accordance with an aspect of the present invention, a process for the computer supported processing of source data elements of a source data quantity involves the following steps:
Entering at least one query data element, particularly a search string,
Determining a weighted link of a query data element with at least one source data element of the source data quantity, particularly with at least one hit string of the source data quantity, and
output of at least one source data element in accordance with a weight of the weighted link, preferably a hit likelihood of the query data element with the at least one source data element, wherein
the weight of the weighted link is determined by means of at least one associative link.

The weighted link may consist of an associative link and vice versa, wherein each associative link or each weighted link is assigned a weight. An associative link between two elements, for instance the query data element and the source data element, consists either of a direct, strongly weighted link or a combination of a sum of weighted paths which connect two or more elements to each other. Consequently an associative link may consist of a direct link or an aggregated, that is, an indirect, chained, etc. link between two elements. An associative link may be constituted by a combination of direct and aggregated links.

In particular, these links or connections between information from differing data sources may, for instance, consist of very different types or the information from differing data sources may also be linked (very) differently. For instance the associative links—in addition to purely numeric weightings—may contain one or further annotations or information for each link, which bear information about the origins, the type and/or the quality of the link. In particular, it is therefore possible for several links to exist between two data source elements, which can be differentiated and/or identified on the basis of these annotations.

In other words, links between two elements (such as an illness and a gene) may exist, which, for example, originate from a gene expression experiment and from an article. In both cases, it is advantageous to make a separate connection or link between the same elements. For instance, one connection or link will provide a reference to text, while the other connection or link will, for instance, provide a reference to experimental data.

It is advantageous as per the invention to be able to create links between information.

The query data element may consist of one or several search string(s), such as a word, several words, a sentence, one or more chemical formula(s), one or more gene sequence(s), etc. The query data element may include further search parameters, and in particular, other freely selectable/open search parameters—the so called “wild cards”.

The source data element(s) may consist of a hit strong, for instance a word, a sentence, a chemical formula, a gene sequence, etc.

In other words, an associative link between the query data element and one or more source data elements can be determined, and in particular, the weight of this associative link can be determined. In particular, the expression of determining “the weight of the weighted link based on an associative link” in the sense of this invention is used in such a manner that each weighted link has a weight assigned to it, and the weight of the weighted link is determined by means of one or more associative link(s), for instance from a table, or it is calculated. In order to determine the weight of the weighted link(s), it is also possible, among other things, to include the context—such as positive and/or negative markings—in the course of the interactive navigation.

The connection between the query data element and the source data element or the source data quantity is advantageously not based on indexes. Rather the link between the query data element and the source data element is made by means of the associative link, and does not represent an index link of a search string with a source data quantity. Therefore the invention moves away from generating indexes with the source data quantity. Rather the query data element, that is the search string, does not have to match the source data element, which is the hit string. Instead, the hit string may be linked to the query data elements by means of a different type of link—the associative link—wherein the associative link has a weight assigned to it. For instance, the search string “Gene A” can be used as a query data element. The source data element may consist, for instance, of the hit string “Protein B”. Even though the query data element and the source data element differ from each other, the source data element “Protein B” is output upon the entry of the query data element “Gene A” when the process in accordance with the invention is used, since there is an associative link between the query data element “Gene A” and the source data element “Protein B”, wherein the associative link is, for instance, founded on the fact that the Protein B can be synthesized by means of the Gene A. In a customary index link, on the other hand, a hit would only be possible if the source data element also consisted of the “Gene A”.

The information can advantageously continue to be present in corresponding databases—there is merely a new connection which is created between the information building blocks/the individual entries in the databases. Associations can be formed by means of automatic analysis through special solution tools, meaning through the use of special algorithms which may take place on one or more computers. It is furthermore advantageous to later add other analysis tools as well as information sources.

Furthermore a user specifically does not have to enter specific queries, but only information which is already available, such as gene description, and relations to these entries are created and output.

The determination of the weighted link of the query data element with at least one source data element may also include the calculation of the links in real time in this process. It is also possible that the link is merely queried, that is, the link was already saved.

A weighted link in the sense of this invention consists of an associative link, particularly a direct link, to which a weight is assigned.

Outputting of the at least one source data element particularly includes—if one or more source data elements were found for one or more query data elements—that these source data elements are output in accordance with their rank. Herein the rank is determined by means of the weighed link. For instance the weighted link can be stated in percent. In particular, the weighted link may be stated as a fraction of the possible maximum value of a weighted link. In other words, if there is a very strong link, the source data element is arranged farther up in its hierarchy than a source data element with a weak link. For instance an associative link between the query data element “Gene A” and the source data element “Protein B” may have a value of 0.9, and an associative link between the query data element “Gene A” and a source data element “Protein C” may have a value of 0.2. When the source data elements are output, the source data element “Protein B” has a higher rank than the source data element “Protein C”.

Through the use of the process as in the invention, it is advantageously possible to provide information without necessarily having to define a clearly formulated query. In particular, possibly important information which is not registered by means of the query can be extracted. As shown above in the example, it is possible to use a query which has not been more specifically formulated to provide information which is associated with it. It is also possible to advantageously provide links between information sources (both within and—where applicable—outside a company).

Consequently the process is not used to model large information databases; instead, it creates relations between all information sources, that is, numerous possible data source quantities or numerous possible data source elements. In particular, external or outside databases or database structures can also be included herein, that is, they can be provided with associative links. Information from outside or external database structures can be connected to existing internal data structures, that is, source data quantities, by means of associative links.

Preferably, a reference data quantity with reference data elements is provided, and a weighted link with at least one source data element of the source data quantity is generated for every reference data element.

In particular, the reference data quantity may equal the source data quantity, that is, the reference data quantity is identical to the source data quantity. In other words, it is possible to merely provide a data quantity which represents both the source data quantity and the reference data quantity. The individual elements of this data quantity can be connected with each other by means of associative links.

Herein the weighted link is an associative link. In other words, it is advantageous not to create indexing of the reference data elements with the source data elements or the source data quantity. Instead, weighted links, particularly associative links, are created between the reference data elements and the source data elements. Herein the reference data quantity may include one or more reference data elements. The source data quantity may include one or more source data elements. It is respectively possible to create one link with each source data element for each reference data element. It is also possible to create a joint weighted link for many reference data elements with one source data element.

It is preferable, during the step of determining the weighted link(s) of the query data element with the at least one source data element, to determine at least one reference data element which corresponds to the query data element, and the link(s) of the at least one reference data element with the at least one source data element are herein assigned to the query data element.

If only a data quantity whose elements are already linked among each other by means of associative links is provided, it is possible to determine at least one element of the data quantity for each query data element which corresponds to the query data elements, and the link(s) of the at least one element of the single data quantity can be assigned to further elements of the single data quantity of the query data element. In other words, it is possible to provide solely the source data quantity, wherein associative links exist between source data elements. For each query data element, at lest one source data element is determined, this may, for instance, be identical to the query data element. The other source data elements which are linked to this source data element may be output in accordance with the weight of their weighted links.

In other words, it is preferable to create all links between the reference data elements and the source data elements in advance, wherein the links can be expanded both automatically and manually on a continuous basis. After entering a query data element, the query data element is compared to the reference data elements of the reference data quantity, and at least one reference data element which corresponds to the query data element is selected. All links of the selected reference data element or the selected reference data elements are assigned to the input query data elements. In other words, all source data elements which are linked to the selected reference data elements by means of associative link(s) are also assigned to the query data element. The source data elements are output in accordance with the weighted links with the reference data element or the reference data elements, wherein the output of the source data elements is hierarchically ordered in accordance with the weighted link or the links to the reference data element(s).

Particular preference is given to a situation wherein the reference data element is identical to the query data element.

Furthermore, each source data element is preferably assigned a supplementary data element of an additional data quantity. The source data element may consist of a part of the supplementary data element, for instance a word of a text or a website.

The supplementary data element may, for instance, consist of a text, a scientific publication, a book, a part of a book, a web page or a digital file, such as a PDF file.

As already stated above, it is advantageously possible to avoid the indexing of one or more supplementary data elements, for instance a website or a text. Rather, it is not necessary that the search string must be contained in the supplementary data element, such as the website or text, as is commonly the case. For instance, after entering the search string “Gene A”, the output may consist of a hit string “Gene B” and a text can be shown which merely includes the hit string “Gene B” but not the search string “Gene A”, since there is an associative link between the search string “Gene A” and the hit string “Gene B”. With a customary search engine, this output would not have been possible.

With particular preference, the supplementary data element of each source data element is provided at output. In other words, when the source data element is output, that is, a hit strong—for instance of a word or formula or another hit string of a webpage or a text or another data structure, the entire data structure or a statement about the identity of the entire data structure can also be output. It is also possible that only a reference, such as a link to this data structure, is provided. Commonly, the hit string and the web address of the web page on which the hit string is available can be provided. Analogously it is also possible to provide a file or a link to this file.

It is also advantageously possible through modeling the links between query data elements and/or source data elements and/or reference data elements—which can also be described as information entities—and the links to the underlying supplementary data elements—that is, in the information sources—to allow a user to not only see the results of the associations, but also to understand the association process itself. Advantageously, it is therefore not only possible to model a large information database, but also to model a relation between all existing information sources.

Furthermore, it is preferable to enter at least two query data elements, determine a source data element for each query data element, and the source data elements are then output in accordance with the weights of their weighted links with the respective query data elements. The two or several query data elements can be linked with a single source data element.

In particular, two or more query data elements can be entered. For instance both the query data element “house” and the query data element “construction” can be entered. The respective source data element may, for instance, consist of the hit string “craftsman”. Furthermore, as already shown above, the query data elements are not identical with the source data element. However there may be an associative link between the query element “house” and the query data element “construction” which is linked to the hit string “craftsman” and therefore the entry of the search strings “house” and “construction” can have the hit sting “craftsman” assigned to it.

For instance a query data element may also consist of the search string “Gene G1”, and the second query data element may also consist of the search string “Gene G2”. It is furthermore possible to assign an associative link to the hit string, which is the source data element “Protein P1”, with the search string “Gene G1”. In other words the reference data quantity may show the reference data element “Gene G1” and there may be an associative link between the reference data element “Gene G1” and the source data element “Protein P1”. It is furthermore possible to assign an associative link to a source data element “Protein P2”, that is the second search string “Gene G2”, with the second query data element. In accordance with the invention, both the source data element “Protein P1” and the source data element “Protein P2” are output. Herein the source data elements are hierarchically output after each other, wherein, for instance, the source data element with the greater value of the associative link is output first. It is, for instance, also possible to assign an associative link to a query data element “Gene G1” with a source data element “Protein P12”. It is furthermore possible to assign the query data element “Gene G2” an associative link with the source data element “Protein P12”. Consequently there is an associative link between the source data element “Protein P12” and the reference data element “Gene G1” as well as the reference data element “Gene G2”. In this case the source data element “Protein P12” is also output, wherein the position in the hierarchy in which the hit string “Protein P12” is output is determined out of the associative links with the reference data element “Gene G1” and the reference data element “Gene G2”.

If two or more query data elements are entered and if at least one query data element shows a link to a source data element for which no other query data element shows a link, it is also possible to output a corresponding report of the single link at the time at which this source data element is output.

The query data element is not linked directly with the source data element—rather, this is done with the reference data element which corresponds to the query data element. The link of this reference data element to the source data element is, however, equated to a direct link of the query data element with the source data element.

Furthermore, a respective link is preferably generated with each element from the quantity of the permutations of the query data elements which are linked with the source data element for each source data element.

In other words a source data element can be linked with N reference data elements R₁ to R_{N}. In this case a link between the source data element and each reference data element R₁ to R_{N} is preferably created. Furthermore it is preferable to provide a shared link for all multiples of two of the reference data elements R₁ to R_{N}, that is for the pairs of the reference data elements (R1, R2), (R1, R3), (R1, R4) . . . (R_{N-1}, R_{N}) as well as for all multiples of three, multiples of four, . . . , (N−1) multiples and N multiples.

Preferably, one or more source data element(s) and/or associative link(s) can be visually displayed. Herein the source data elements and if applicable, the links between the source data elements can be shown. In other words the searchable data structure and/or the searchable network can be displayed. In particular, it is possible for the associative links and the values of the weights to be shown.

At least one source data element is preferably predetermined and a positive or negative potential is assigned to this at least one predetermined source data element. With particular preference, a greater number, in particular all source data elements and/or associative link(s), can be visually displayed, the source data elements can be (visually if applicable) dialed or selected by a user, either individually and/or in groups, and it is possible to assign the respective positive or negative potentials to the selected source data elements or to assign activities to them.

If there are additional elements between the two elements which are linked by means of an associative link, for instance further source data elements, these elements can be provided with a negative potential, that is a negative activation, and may lead to a weakening of this associative link, that is, to a lower weight of the weighted link.

Preferably the predetermination of the at least one source data element and the assignment of the positive or negative potential can be manually performed by a user. For instance one or more source data element(s) and/or associative links can be selected by the user and corresponding potentials can be assigned. In particular one or more source data element(s) and/or associative links can be selected by the user by means of the visual display, for instance, by selecting source data element(s) and/or associative link(s) on a computer screen. In particular, the user is therefore able to interactively determine the source data quantity which is to be used, that is, the relevant source data elements, or restrict or specify this source data element quantity.

With particular preference, the predetermination of the at least one source data element and the assignment of the positive or negative potential by the user can be performed before entering the at least one query data element. It is therefore possible for the user to precisely specify the source data elements in a simple manner before the first query. After the first query, the user may determine further source data elements and/or associative links, and so forth.

It is preferably possible to assign a potential to each reference data element or each source data element. The potential may be positive or negative. If, for instance, a positive potential is assigned to a source data element, all further source data elements which are linked with the source data element can be utilized for output. If a positive potential is assigned analogously to a reference data element, all source data elements which are linked with the reference data element and all other source data elements which are linked with these source data elements can be utilized for output. If a negative potential is assigned to a source data element, all other source data elements which are directly linked with the source data element cannot be utilized for output. All further source data elements which are linked to the additional source data elements can, however, are used for output. In other words negative potentials can be used to exclude individual source data elements in the search. If, for instance, in a search or determination of the links, the quantity of the source data elements is taken along a route via the links between the source data elements, this route is blocked at a source data element with a negative potential. Direct links of these excluded source data elements with other source data elements which do not show a negative potential can be excluded, that is these source data elements (without negative potential) cannot be accessed via the source data elements with negative potential. A link of the source data elements without negative potential to other source data elements, for instance also without negative potential, does, however, continue to remain possible. Consequently these source data elements without negative potential can, if applicable, be reached by other routes.

In other words the negative potentials of individual source data elements can also influence other source data elements to which no negative potential is assigned. If, for instance, a first source data element is linked to a second source data element which shows negative potential, this negative potential of the second source data element may also be automatically included into all further links of the first source data element. For instance the weights of all further direct and/or indirect links of the first source data element may be reduced or may remain equal in terms of the amount, however the prefix of the weight is altered, that is, it is made negative. In particular a link of a source data element may be made more difficult or the weight of a weighted link may be low, since this source data element—via direct and/or indirect associative links with large weight—is linked with source data element(s) with negative potential.

Occupying selected source data elements with negative potential may therefore show itself in that all direct links of source data elements with negative potential are excluded in the determination of the links. A direct link of a source data element Qᵢ with negative potential may consist of a link with the weight wᵢⱼ between the source data element Qᵢ with negative potential and a further source data element Qᵢ.

The output furthermore advantageously does not consist of a static list of query results, but a visual representation of possible associations, that is links which were built up by the analysis tools over the course of time.

With particular preference, the following takes place in the determination of the weighted link(s) of the query data element with at least one source data element in an iteration step
a first source data element is determined for each query data element,
a weighted link with another source data element is determined for each first source data element,
each first source data element is defined as a query data element, and
each further source data element is defined as a first source data element.

In other words a first source data element is determined for each query data element as described above, that is a reference data element of the reference data source is determined for each query data element and the link of the reference data element with the first source data element is assigned to the query data element. Furthermore the first source data element may be linked with one or more further source data elements. The further source data element (which is linked directly with the first source data element) is then defined as the first source data element, that is a link is created between the reference data element and the further source data element, wherein the link of the reference data element and the further source data element replaces the link between the reference data element and the first source data element. The weight of the weighted link of the reference data element with the further source data element may, for instance, correspond to the value of the link of the first source data element with the further source data element. The value of the weighted link of the reference data element with the further source data element may also be specified or determined, and particularly calculated, on the basis of the link of the reference data element with the first source data element and the link of the first source data element with the further source data element. In the output of the source data element which belongs to the query data element, it is consequently now only possible to use the further source data element which was defined as a first source data element.

The iteration step is repeated with particular preference.

Preferably the first source data element(s) is/are output after the first iteration step.

Preferably each first source data element is output in accordance with the weight of its weighted link. With particular preference, the query data element(s) is/are already output before the iteration step in this process.

Furthermore it is preferable that each further source data element which shows links with several first source data elements respectively has one link with each element from the quantity of permutations of the first source data elements which are linked with the further source data element generated for it.

The reference data quantity and the source data quantity may, for instance, are structured in the form of layers. The reference data elements of the reference data quantity are arranged in a first layer. A large variety of source data elements of the source data quantity are arranged in a next layer. The reference data elements are linked with the source data elements by means of associative links, and in particular, they are directly linked. Further source data elements may be arranged in a further layer, wherein the source data elements of the various layers are linked with each other by means of associative linking. Furthermore any desired number of further layers of source data elements may follow, wherein the source data elements of the various layers are linked to each other by means of associative links. Source data elements in further layers show no direct link to reference data elements. If a query data element is entered, a reference data element is specified or determined for this query data element. The reference data element is located in the layer of the quantity of the reference data elements. The reference data element is directly linked with at least one source data element of the layer of the source data elements which is directly adjacent to the layer of the reference data elements. This source data element is described as the first source data element. The first source data element is located in the first layer of the source data elements.

The first source data element is linked with a further source data element of the layer which is adjacent to the first layer of the source data elements by means of an associative link. Likewise all source data elements of this layer may be linked with the source data elements of the following layer, etc.

If the process in accordance with the invention is performed iteratively, links of the reference data elements with source data elements in deeper layers, that is source data elements which are located in layers farther away from the layer of the reference data elements, can be specified or determined. In each iteration step, links to source data elements in a deeper layer can be determined. Consequently, advantageously starting from a query data element or from a reference data element which corresponds to the query data element, a large number of source data elements from various layers can be determined or a source data element can be output which has no direct link(s) to the reference data element or the correspondingly assigned query data element.

Preferably each first source data element is output in accordance with its weighted link, with the respective query data element.

The source data quantity is preferably expandable, and with particular preference, further source data elements and/or further additional elements of the reference data quantity are added and weighted links are generated between the additional source data elements and the corresponding additional reference data elements. In particular, improved analysis methods or manual processes can be used to add new weighted links between existing reference data elements and existing source data elements or the values, that is, the weightings of already existing weighted links can be changed.

Herein the source data quantity can be expanded either by any desired user and/or by special users with predefined access rights, such as an administrator.

For instance a user can provide a further supplementary data element in the form of an internet page or publication, such as and in particular a scientific publication, and for instance, pass the respective data on to an administrator or provide a link to these files.

Preferably weighted links are generated between the additional source data elements with the already existing reference data elements and/or weighted links are generated between the additional reference data elements and the already existing source data elements.

Based on the supplementary data elements and/or the additional source data elements, further reference data elements can be provided. For instance the reference data elements can largely correspond to the source data elements. From the newly added additional source data elements and/or newly added supplementary data elements, associative links can be created to the new, additional reference data elements and if applicable to the already existing reference data elements. Herein the associative links can be manually or automatically generated. For instance such links can already be provided in the provision of the additional source data elements and/or the additional supplementary data elements. The associative links may, however, also be generated using various mathematical algorithms and/or various threshold parameters and/or various exclusion criteria etc. For instance a user of the process as per the invention may provide additional information in the form of computer files, web pages etc. An administrator can link the files and/or web pages to the already existing source data elements and/or supplementary data elements or add them and use a computer program to create the associative links which are newly created in order to enter the new additional data into the already existing data structure.

Preferably, by means of inclusion of new analysis tools and/or new information sources, it is also possible to expand the complexity of the developing information network continuously and in any desired manner. The option of manual follow-up processing of associative links, for instance by means of correction or new entry of such associative links, enables successive modeling and therefore storage of expert knowledge without losing information in general.

Furthermore the weight wᵢⱼ of the weighted link between a reference data element Rᵢ and a source data element Qⱼ is preferably calculated from the frequency of the occurrence of the reference data element Rᵢ and the source data element Qⱼ respectively in a supplementary element as follows:

$${w}_{ij} = \frac{f ( {R}_{i} , {Q}_{j} )}{{f}_{Q} ( {R}_{i} ) {f}_{Q} ( {Q}_{j} )} ,$$

wherein

f(Rᵢ, Qⱼ) represents the frequency of the joint occurrence of the reference data element Rᵢ and the source data element Qⱼ in the supplementary data element,

f_{Q}(Rᵢ) represents the frequency of occurrence of the reference data element Rᵢ in the total quantity of all supplementary data elements and

f_{Q}(Qⱼ) represents the frequency of the occurrence of the source data element Qⱼ in the total quantity of all supplementary data elements.

The supplementary data element may, for instance, consist of a text. The reference data element is a search string which occurs, for instance, in the text. The expression f(Rᵢ, Qⱼ) represents the frequency of the joint occurrence of the hit string and the search string in the text. The expression f_{Q}(Rᵢ) is the frequency of occurrence of the search string in the total quantity of all supplementary data elements. This may for instance consist of the entirety of all texts to be searched. Analogously f_{Q}(Qⱼ) represents the frequency of occurrence of the hit string in the entirety of all texts to be searched.

Preferably the weight wᵢⱼ of the weighted link between a reference data element Rᵢ and a source data element Qⱼ is calculated as follows:

$${w}_{ij} = \frac{\vert \{ \vec{x} \text{:} {R}_{i} ( \vec{x} ) \geq θ ⋀ {Q}_{j} ( \vec{x} ) \geq θ \} \vert}{\vert \{ \vec{x} \text{:} {R}_{i} ( \vec{x} ) \geq θ \} \vert + \vert \{ \vec{x} \text{:} {Q}_{j} ( \vec{x} ) \geq θ \} \vert}$$

wherein
|{\vec{x}:Rᵢ(\vec{x})≧θ̂Qⱼ(\vec{x})≧θ}| represents the frequency of simultaneous occurrence of the reference data element Qⱼ, for instance a gene B, in an experiment \vec{x}, wherein the frequency of the reference data element Rᵢ and the source data element Qⱼ is respectively larger than a threshold parameter θ,
|{\vec{x}:Rᵢ(\vec{x})≧θ}| represents the frequency of sole occurrence of the reference data element Rᵢ, for instance a gene A, in an experiment \vec{x}, wherein the frequency of the reference data element Rᵢ is greater than a threshold parameter θ; and
|{\vec{x}:Qⱼ(\vec{x})≧θ}| represents the frequency of sole occurrence of the source data element Qⱼ, for instance a gene B, in an experiment x, wherein the frequency of the source data element Qⱼ is larger than a threshold parameter θ.

The frequency may, for instance, consist of the quotient of the measured number of experiments in which this gene was proven with a measurement parameter greater than the threshold parameter, as compared to the total number of experiments. In particular, the gene is deemed to be confirmed in individual experiments when a predetermined or predeterminable threshold parameter Θ is exceeded.

In accordance with a further aspect of the present invention, a process for processing source data elements in a source data quantity includes the following steps:
Entry of several query data elements, particularly several separate search strings;
determination of a joint weighted link of all query data elements with at least one source data element of the source data quantity, in particular with at least one hit string of the source data quantity, and
Output of the at least one source data element corresponding to a weight of the jointly weighted link with the query data elements, preferably a hit likelihood of the query data elements with the at least one source data element, wherein
   the weight of the link is determined on the basis of an associative link.

In accordance with a further aspect of the present invention, a system for processing source database elements of a source database includes the following:
an input device which is designed for entry of at least one query data element, in particular a search string;
a microprocessor device which is designed for the determination of a weighted link of the query data element with at least one source database element, particularly with at least one hit string of the source database; and
an output device which is designed for output of the at least one source database element corresponding to a weight of the weighted link, preferably a hit likelihood of the query data element with the at least one source database element, wherein
   the microprocessor device is furthermore designed for determining the weight of the link on the basis of at least one associative link.

The system preferably furthermore possesses a reference database with reference database elements and

the microprocessor device is designed to generate a weighted link with at least one source database element of the source database for each reference database element.

Furthermore, the microprocessor device is preferably designed as follows:
during the step of determining the link(s) of the query data element with the at least one source database element, to determine at least one reference database element which corresponds to the query data element, and
to assign the link(s) of the at least one reference database element with the at least one source database element to the query data element.

With particular preference, the system furthermore includes a supplementary database and each source database element has a supplementary database element assigned to it.

Furthermore, the output device is preferably designed so that it provides the supplementary database element with the output of each source database element.

The source database is preferably expandable with additional source database elements, and/or the supplementary database with additional supplementary database elements.

With particular preference, the microprocessor device is designed to generate additional reference database elements with the additional source database elements and/or the additional supplementary database elements and to generate weighted links between the additional source database elements and the corresponding reference database elements.

The input device and/or output device is preferably designed so that one or more source data element(s) and/or associative link(s) are visually shown.

Furthermore the input device is preferably designed to predetermine at least one source data element and assign a positive or negative potential to the at least one source data element.

Preferably the input device is designed so that the predetermination of the at least one source data element (62) and the assignment of the positive or negative potential can be manually performed by a user.

With particular preference, the input device is designed so that the predetermination of the at least one source data element (62) and the assignment of the positive or negative potential by the user can be performed before entering the at least one query data element.

In other words, the input device together with the output device represents an interactive user interface with which the user can modify the source data elements and/or the associative links and explore the output.

In particular, the above explanations about the process also apply analogously to the system in accordance with the invention.

In accordance with another aspect of the present invention, a computer program product which—when loaded into the memory of a data management system such as a computer—causes the data processing system to perform the process in accordance with the invention.

The present invention is described in an exemplary manner by means of the following diagrams. Identical reference symbols in various figures describe the same components. The invention is not limited to the embodiment forms as described in the examples. Instead combinations of individual attributes of subsequently described embodiments or -variants with each other are possible. The invention is not limited to the embodiment forms as described in the examples.

The following are shown:

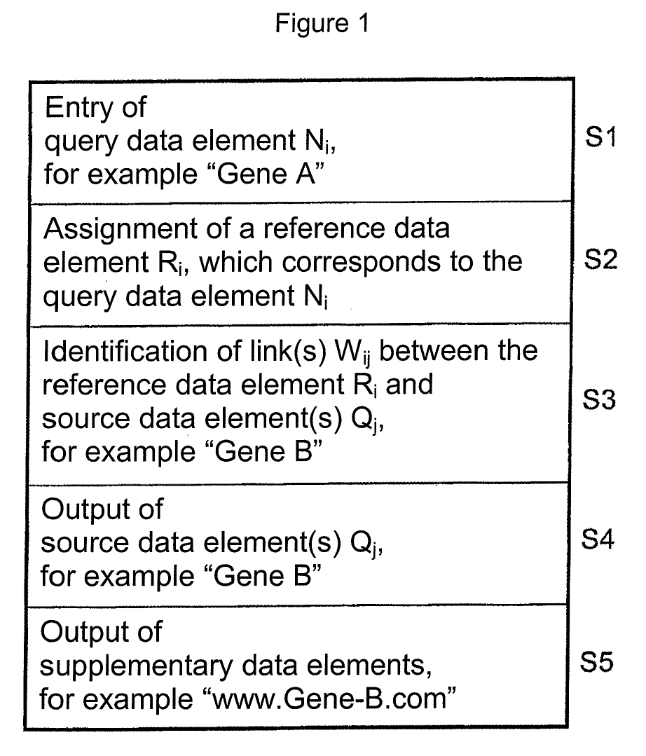

FIG. 1: a flow diagram of an embodiment variant of a preferred process of the invention;

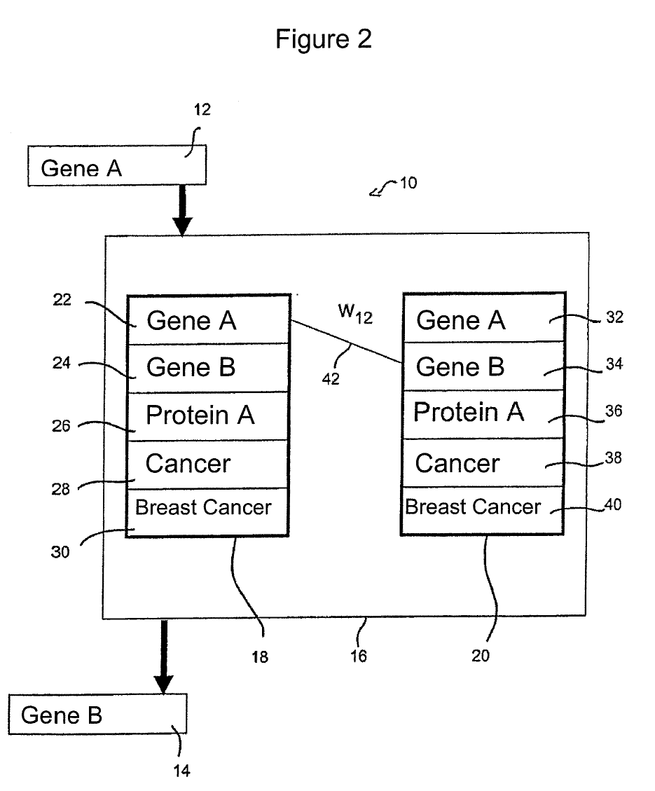

FIG. 2: a schematic view of an embodiment of a preferred system of the invention;

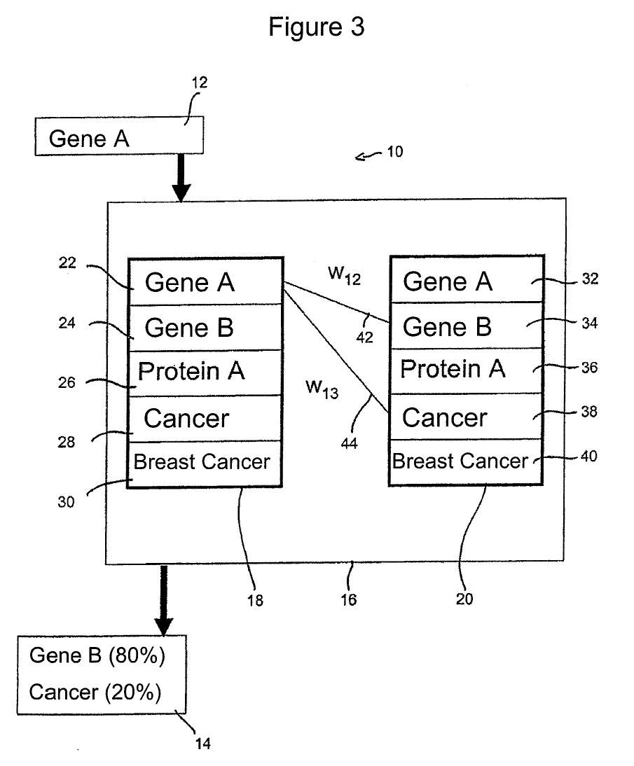

FIG. 3: another schematic view in accordance with FIG. 2;

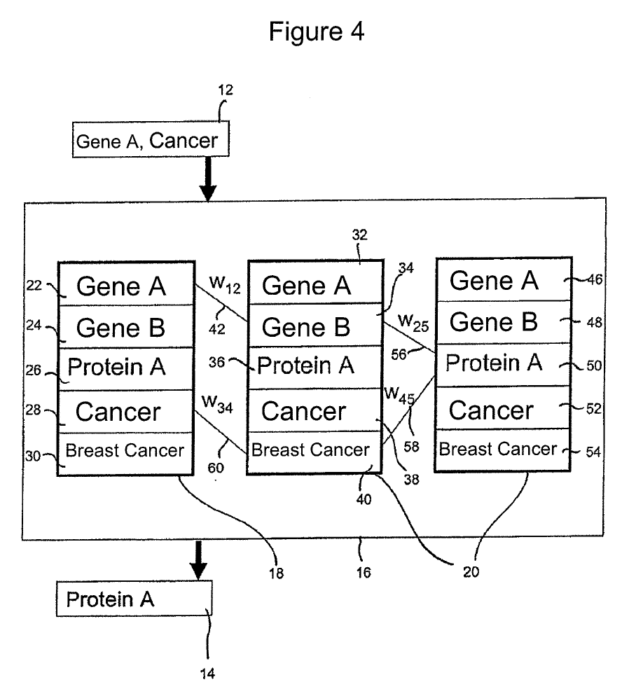

FIG. 4: another schematic view in accordance with FIG. 3;

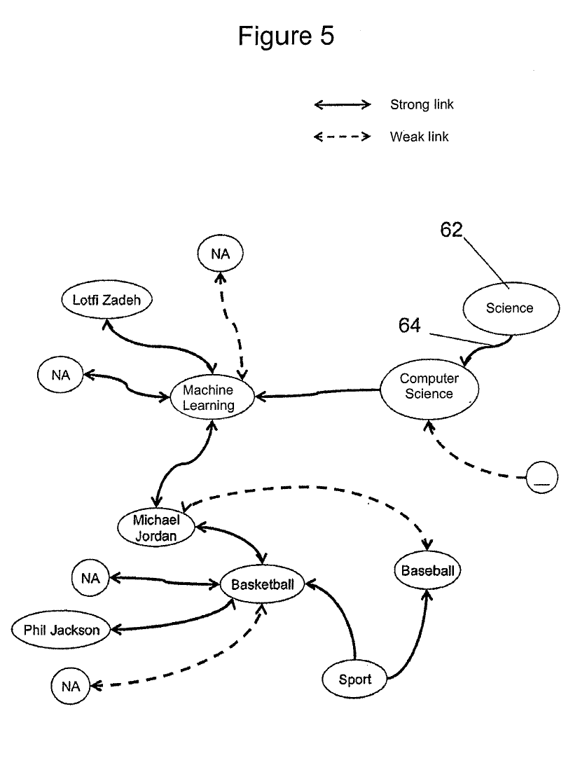

FIG. 5: another schematic view of another preferred embodiment of the invention;

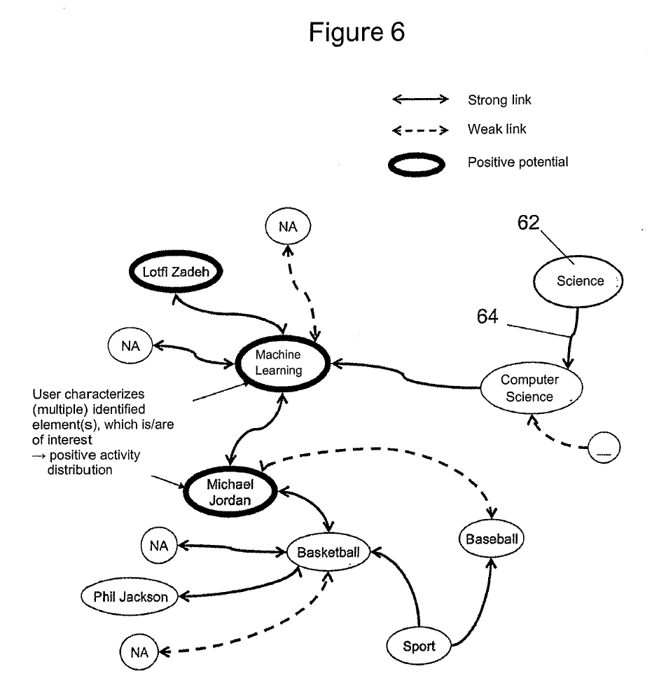

FIG. 6: a schematic view in accordance with FIG. 5;

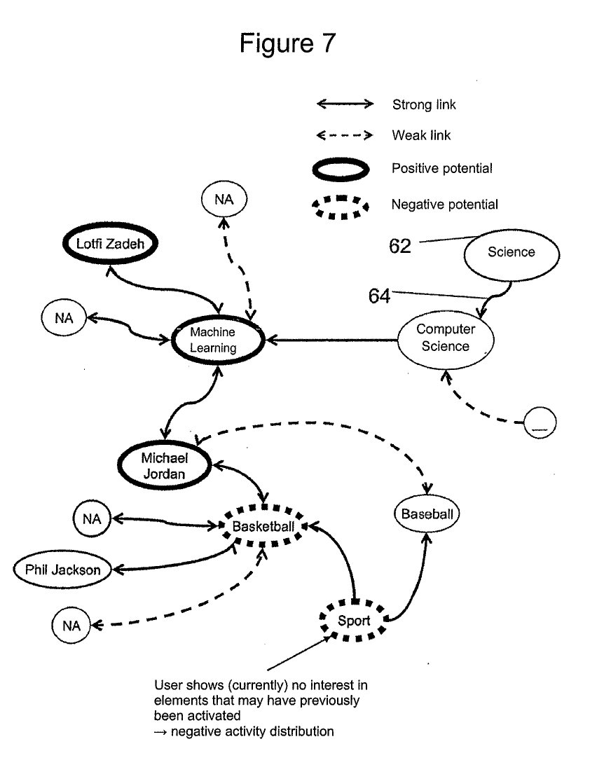

FIG. 7: a schematic view in accordance with FIG. 5;

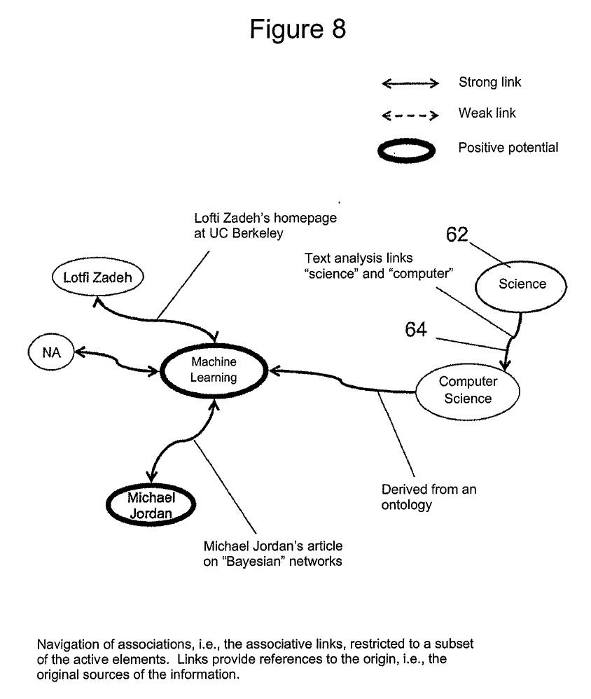

FIG. 8: a schematic view in accordance with FIG. 5; and

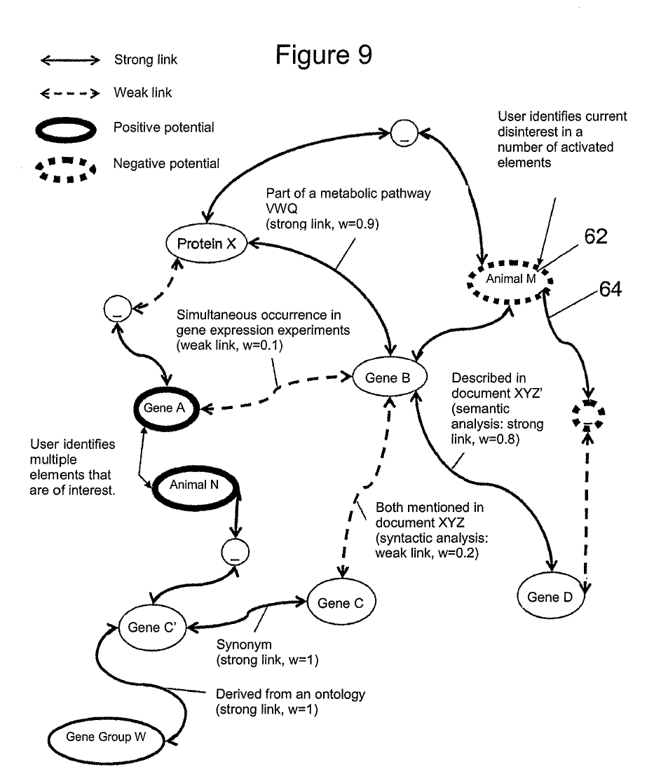

FIG. 9: a schematic view in accordance with another preferred embodiment of the present invention;

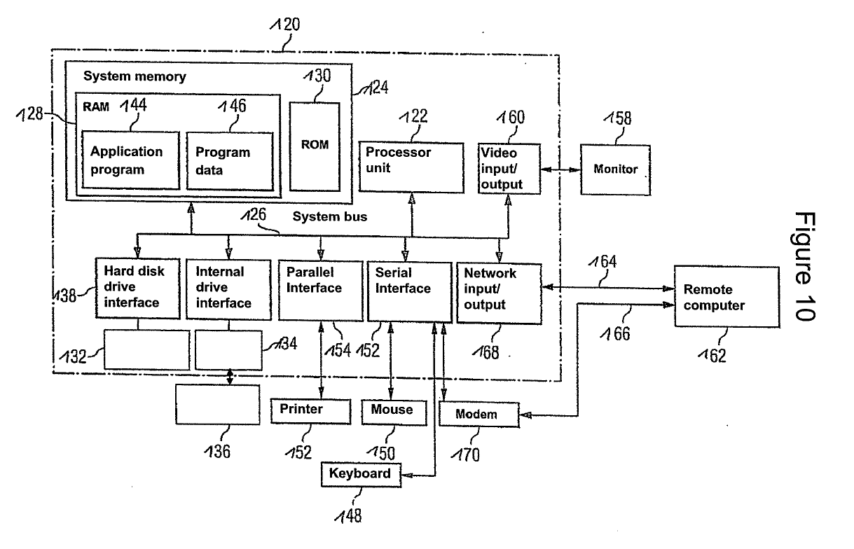

FIG. 10: a schematic view of a computer system.

The subsequent description of the figures uses a large variety of specialized terms which are briefly explained.

An object (English: entity) may consist of a node in a network.

A link (English: link) may consist of a connection, particularly an associative link between two objects. The description of the present invention makes synonymous use of the terms “link” and “connection”.

Weight (English: weight) may be the strength of a link or association which is to be assigned to a link. An association corresponds to an associative link as described above.

A pointer (English: reference) can be assigned to a link. Each link may also contain one or more references which point at an original source which served to introduce the link. A summary of this source may be added as a supplement to the reference or references, for instance if the original source is no longer available or was removed. For instance a reference may consist of a URL or an address on the World Wide Web.

An explanation (English: annotation) may be added in addition to every link in order to provide further information, in particular a description of the link and/or the entities, a reason or origin of the link, etc. Annotations are regularly added manually by a user or edited.

An activity (English: activity) can describe an object. In particular each object as a node of a network may possess a specific activity level. For instance the activity may be shown in the form of a negative or positive potential. For instance the activities may be interactively determined or changed by a user.

A description (English: label) defines the context of a link. A description may also be a relation to an instance or ontology.

An analysis device (English: analysis engine) creates links with corresponding weights and references on the basis of one or more information sources. An analysis engine is largely an agent for extracting information on whose basis links are created.

FIG. 1 shows a flow diagram of a preferred embodiment of the process in accordance with the invention. In a first step S1, a query data element Nᵢ—such as the search string “Gene A”—is entered. Entry may take place, for example, using a keypad into a data processing system such as a computer. Herein access to a subsequent data structure may take place directly. However entry may also be performed via a terminal. Herein the terminal may be connected to the subsequent data structure via a network. Alternatively, entry may also be performed via e-mail, SMS or by other means to the subsequent data structure. In the step S2, the query data element Nᵢ is assigned a reference data element Rᵢ of a reference data quantity. In other words the reference data quantity includes numerous entries and in the herein selected sample, an entry is sought which is identical or at least similar to the search string “Gene A”. If such an entry is found in the reference data quantity, the respective reference data element Rᵢ is assigned to the query data element Nᵢ.

The reference data element Rᵢ, which—for instance—corresponds to the search string “Gene A”, possesses, for instance, at least one link with a source data element Qⱼ. For instance the reference data element Rᵢ may show the associative link with the weight wᵢⱼ with the source data element Qⱼ. The source data element Qⱼ may, for instance, consist of the hit string “Gene B”. The hit string “Gene B” serves as output, for instance on a monitor of the input computer or the terminal, or as an e-mail or SMS. It is furthermore possible to provide additional information for the hit string.

In the step S5, for instance, a supplementary data element is simultaneously or upon user request output in the form of a URL with the address “www.Gene-B.com” with the hit string. Furthermore any desired other information can be output, particularly a scientific publication, an excerpt from a book, an ISBN number, a PDF document, etc.

FIG. 2 shows a schematic view of a system 10 in accordance with a preferred embodiment of the invention. The system 10 comprises an input device 12 and output devices 14 are connected to a data management system 16. The data management system 16 may consist of a local system such as a computer. However the data management system may also be part of a larger network. In particular, the data management system 16 does not have to possess a physical connection to the input device 12 and the output device 14. Rather the data management system 16 may possess a decentralized network structure. The data management system 16 may also include a database, particularly a database cluster.

The input system 12 and the output device 14 can be part of a computer (not shown), a terminal (not shown), and a mobile telephone (not shown), a PDA (not shown), etc. The input device 12 and the output device 14 may consist of a single unit. For instance a touch screen may serve as an input device 12 and an output device 14. The system 10 may also comprise a large number of input devices 12 and output devices 14.

The input device 12 is used to enter a search string into the data management system 16. In accordance with FIG. 2, the search string is the term “Gene A”. Consequently the input device 12 is used to enter the term “Gene A” into the data management system 16, for instance sent via SMS or e-mail, or transmitted by means of another protocol, or entered directly via a keypad.

In the example shown in FIG. 2, the data management system 16 includes a reference database 18 and a source database 20. Herein, however, it is not necessary for the reference database 18 and/or the source database 20 to each consist of a physical unit. Rather both the reference database 18 and the source database 20 may include a large number of databases or consist of a decentralized database structure. The individual components of the reference database 18 or the source database 20 may be connected with each other via one or more networks.

The reference database 18 includes, for instance, 5 reference database elements 22, 24, 26, 28, 30. The source database 20 includes, for instance, 5 source database elements 32, 34, 36, 38, 40. The reference database elements 22, 24, 26, 28, 30 include 5 symbol strings, namely “Gene A”, “Gene B”, “Protein A”, “cancer” and “breast cancer”. These five reference database elements 22 are merely exemplary reference database elements. Each reference database 18 may largely possess any desired number of reference database elements, which may largely consist of any desired content, for instance a chemical formula, a symbol string, a mathematical expression, etc.

The source database 20 furthermore includes five source database elements 32, 34, 36, 38 and 40. The source database elements 32, 34, 36, 38 and 40 are shown in an exemplary manner as symbol strings.

FIG. 2 furthermore shows a link 42 between the reference database element 22 with the content “Gene A” and the source database element with the content “Gene B”. The link 42 has the weight w₁₂. The weight w₁₂ may, for instance, possess a numerical value such as 0.9. The link 42 is an associative link 42.

Furthermore other associative links may be present between the reference database elements 22, 24, 26, 28, 30 and the source database elements 32, 34, 36, 38, 40. For the sake of clarity, however, no further links were drawn in.

If the input device 12 is used to enter the search string “Gene A” into the data management system 16, a reference database element which corresponds to the search string “Gene A” is determined. In this case the reference database element 22 is determined. The reference database element 22 is linked to the source database element 34 via the link 42. The link 42 is preferably assigned to the entered search string. Therefore the source database element 34 is output via the output device 14. In other words the output device 14 shows the hit string “Gene B”. Furthermore the output 14 can also show the hit likelihood in the form of the value w₁₂.

FIG. 3 shows a schematic view in accordance with FIG. 2 wherein an additional link 44 of the reference database element with another source database element, the source database element 38, is furthermore shown. Consequently, if the input device 12 is used to enter the search string “Gene A” into the data management system 16, both the source database element 34 and the source database element 38 are output. In other words both the hit string “Gene B” and the hit string “cancer” are output, wherein the output takes place in hierarchical order and the hit string with the higher value of the link 42, 43 is output first. For instance if the value of the weight w₁₂ of the link 42 w₁₂=0.9 and the value of the weight w₁₃ of the link 43 w₁₃=0.7, the output of the hit string “Gene B” takes place prior to the output of the hit string “cancer”. If applicable, the value of the respective weights may also be stated. Other information such as supplementary information which is linked to the respective source database elements 34, 38 may also be output.

FIG. 4 shows another schematic view of a preferred system 10. Aside from the source database elements 32, 34, 36, 38, 40, the source database elements 46, 48, 50, 52, 54 are also shown. Furthermore links between the source database elements 32, 34, 36, 38, 40 and the source database elements 46, 48, 50, 52, 54 are possible. For the sake of clarity, only a link 56 was drawn in between the source database element 34 and the source database element 50 as well as a link 58 between the source database element 40 and the source database element 50. The link 56 has the weight w₂₅, while the link 58 has the weight w₄₅. Furthermore a link 60 is drawn in between the reference database element 28 and the source database element 40. The links 42, 56, 58, 60 can be manually or automatically generated. For instance the link 42 can be created on the basis of a scientific publication in which both the string “Gene A” and the string “Gene B” are frequently used. For instance the link 60 between the reference database element 28 and the source database element 40 results from the fact that breast cancer is a form of cancer. Consequently the weight w₁₂ of the link 42 may, for instance, be created on the basis of the frequency of use of the string “Gene A” and the string “Gene B” in one or more texts. The weight w₃₄ of the link 60 may, for instance, possess a fixed value such as 1.0, wherein this value is assigned, for instance, by an administrator or expert in the field.

The source data quantity may be saved in one database or various databases. Furthermore the layer form merely represents a preferred embodiment. For instance the source data elements may all be arranged in a layer and source data elements may have several links, as shown in an exemplary manner for the source data element 22 and the links 42, 44 in FIG. 3, and the links may be followed successively.

In other words, the data management system 16 consists of nodes 22-40, 46-54 and marked edges. Each node represents an object, which may consist of a concept of the application field such as an illness or metabolic route or a metabolic path, or a named object such as a gene, protein or specific goal. Edges represent links between these objects and are marked with a reference to the information source(s) or information about the analysis system, such as a computer, which generated the links based on these sources. Each edge furthermore includes a weight which models the strength of the association and an identity which states the type of edge. In this way a link may also be possible to derive from an ontology which represents semantic connections between the nodes.

If the input device 12 is used to enter both the search string “Gene A” and the search string “cancer” into the data management system 16, the output device 14 may output both the hit strong “Gene B” and the hit string “breast cancer”. However it is not possible with this example to assign a weight to the hit string “Gene B” using both search strings. Likewise it is not possible to assign a weight to the hit string “breast cancer” using both search strings. Consequently these two hit strings do not represent ideal results. However the links 56, 58 can also lead to an output of the hit string “Protein A”. Herein the hit likelihood can be determined using the weights of the links 42, 56, 58, 60. Consequently the values can be used to determine the hit likelihood of one or more of the weights w₁₂, w₃₄, w₂₅ and w₄₅.

This might advantageously be used to create new ideas. In particular, this does not merely answer questions, but on the basis of the further link of source database elements 33-40, 46-54, new connections are recognized/created and output, wherein access to all possible data which were entered into the data management system 16 is implicitly enabled. Advantageously, interesting and particularly not readily evident links between information sources can be created and researched. Through a further connection of the source database elements 32-40, 46-54 with external sources, such as web pages, files etc., further information can be provided and/or the origin of the links may be self-explanatory. In particular, expert experience and/or expert knowledge are also tied in, since links 42, 56, 58, 60 can be created automatically as well as manually by experts.

In particular, it is possible to assign values to the weights w₁₂, w₂₅, w₂₄, w₄₅ automatically or by experts. The links of all possible combinations of the individual source database elements 32-40, 46-54 can be created originating from the reference database elements 22-30, wherein—for instance—the expert knowledge for all persons with access authorization can be provided throughout the entire company. It is also possible, particularly via the internet, to link in further information sources or link them to the data management system 16, or the internal data structure can be connected with a superior data management system 16.

Furthermore it is not only possible to find information on a website, but also, particularly due to the links of the source database elements 32-40, 46-55 with each other, information can also be found, processed and included from various domains. The option of enlarging and administering the data management system 16 as desired enables continuous dynamic learning, wherein no reset is possible and/or mechanisms cannot be forgotten. In other words the system 10 represents an expansion of the knowledge/the knowledge base of the users.

In order to generate the data management system 16, weighted links must be created between the individual objects that are between the reference database elements 22-30 and/or the source database elements 32-40, 46-54. There are two fundamental options for adding objects and links to a data management system 16 or providing the links between the already existing reference database elements 22-30 and/or the source database elements 32-40, 46-54. The links can be generated automatically or manually, wherein the weighted links can also be generated automatically or manually/automatically generated links can, for instance, also be changed manually. Likewise a part of the links can be generated automatically and another part manually.

For automatic generation of links and weights, analysis systems such as one or more computers are used. Links between existing nodes, such as the source database elements 32-40, 46-54, can also be added and/or changed. Each analysis system may have a specific task, such as finding repeated occurrence of words in documents, correlations of genes in gene expression experiments, structural activity relations via the analysis of cell assay images, that is a large numbers of images, or connections between genes and diseases using analysis of patient information. By comparison, this would represent the collection and modeling of automatically derivable knowledge domains. By adding new analysis engines, such as new algorithms for creating or changing links, the network can be continuously maintained, improved and expanded.

Weights and links can also be added and/or changed through manual intervention by a user. For instance a user can mark links as false or provide new links with additional explanatory information. This interactive improvement makes it possible to collect expert knowledge and furthermore enables immediate feedback which allows the data management system 16 to model expert knowledge within a company or within the system 10. Manual interaction should be handled in an intuitive manner. In particular a user does not have to manually adapt numeric weights, change them or create new links between abstract nodes.

Consequently the data management system 16 can be expanded through the addition of further supplementary data, particularly further source database elements. It is also possible to expand the data management system 16 by adding new links to already existing reference data elements 22-30 and/or source database elements 32-40, 46-54.

FIG. 5 shows a schematic view of a data management system 16. However FIG. 5 may also represent an exemplary output of an input device 12 in which the content of the data management system 16 is schematically shown. In particular, FIG. 5 shows a large number of source database elements 62 as well as links 64 between the source database elements 62. The arrows of the links 64 show in which direction the link can take place. An arrow on both sides shows that a link can take place in any direction. An arrow on one side shows that a link can take place only in one direction. Continuous lines indicate strong links while dotted lines indicate weak links. In other words the weights which are assigned to links have a high numeric value for strong links.

The weights of weak links have a small numeric value. A user can place positive or negative potential on the source database elements 62. Negative potential means that these source database elements 62 are suppressed in the search for links. Positive potential means that these source database elements 62 should be given particular attention.

The one sided link from “sport” to “baseball” means that starting from the node or source database element 62 “sport”, the node or source database element 62 “baseball” can also be found. However it is not possible to find the node 62 “sport” starting from the node 62 “baseball”.

As shown in FIG. 6, one or more source database elements 62 can have a positive potential applied to them. In this example the source database element 62 with the identity “Michael Jordan” and the identity “machine learning” have positive potential applied to them. This can be performed by clicking, e.g. with a computer mouse.

As shown in FIG. 7, source database elements 62 can also have negative potential applied to them, in this case the source database element 62 with the identity “sport”. Due to the negative occupation of the source database element 62 with the identity “sport”, the quantity of possible associations or associative links 64 is restricted as shown in an exemplary manner in FIG. 8.

In other words an associative link can be enabled between data from differing data sources, wherein data and/or data sources of different types can, in particular, be associatively linked. Herein the associative link of the data sources may, for instance, be generated using one or more associative links of data or data elements which may respectively differ. The links may include a large variety of information. For instance each associative link may be laid out for containing at least one item of information about the type of link and/or the origin of the link and/or the weight or the value of the weight of the link etc. The link may therefore include a numeric figure as an example of a weight. Alternatively/additionally, the link may also contain a memory address and/or an address of a computer, server, database, file etc. about the origin of the link. Such an address may also consist of a customary link or internet link or a hyperlink, such as www.wikipedia.com etc. Alternatively/additionally, the link may also contain information about the type of link. This may be a number or letter code or a possible other practical mode of information.

Consequently it is advantageously possible, originating from the associative link, to obtain conclusions about the type and reason for the link. The supplementary information can also be described as an annotation.

In particular, an interactive advanced search in data is therefore advantageously not required. For instance no internet structure or “local area network” (LAN) and in particular, no network for “exclusive” data transmission is required. Thereby an associative link differs in that an advanced search via synonyms or a provided synonym list is not the only available method. Rather, other information, for instance the above named annotations, is also present/taken into account. Therefore a network which differs from the previously stated network is intended. Furthermore an association finding process is advantageously intended which differs from the previously stated advanced search with synonyms particularly in that links are shown which are automatically found in data and/or automatically specified in greater detail.

Also advantageously, not only one database (which can be as complex as desired) is planned, whose contents can be linked by means of associative links. In particular, it is not necessary to find information using predefined structures and it is furthermore not necessary to include a semantic network. Consequently it is advantageously not necessary to specify a predefined network and/or generate it using a database. Therefore it is particularly advantageously not necessary to classify entries in a database. Therefore, instead, (further) links are generated between information. Therefore it is particularly advantageous that there is no restriction of the search to a precisely structured database. Rather, information from various databases is linked.

Also advantageously, no pure text search system is intended. For instance a ranking function which may—for instance—use various static similarity directories or can send the same is not exclusively or preferably utilized. Likewise no exclusive restriction to weighted ranking functions with—if applicable—possible detours via synonyms is intended. In particular, associative links affect not only the process of finding the matching texts, but preferably the linking of various information sources and/or databases.

Finally, the associative link does not merely correspond to a text summarization and/or retrieval system. In particular, the associative link is not merely based on summarizing texts and adapting this summary by means of predefined or predefinable key words. In particular, the previously stated system is not based on a predefined or predefinable structure of a terminology, similar to ontology. Rather, relations are preferably not only extracted from information sources and/or particularly not only from texts and/or must furthermore advantageously not be predefined

Also advantageously, the use of sense of the term “association” and/or “associative link” is not limited to simple text and/or an otherwise specified connection, such as ontology and/or synonyms.

Therefore links preferably include, in addition to the exemplary numeric weights, further information which can be identified as annotations in an exemplary manner.

In other words some links 64 are occupied with further information or annotations as is also shown. Therefore navigation of the associations, that is the associative links, is limited to a partial quantity of the active elements. The links show references about the origins, that is the original sources of the information. The user can now enter a search string by means of the input device 12. The possible associative links 64 which can be searched on the basis of occupation with positive or negative potentials and evaluated if applicable are shown in FIG. 8.

FIG. 9 shows another example of a data management system 16 wherein pharmaceutical links are shown. It is also shown in an exemplary manner that specific source database elements 62 are occupied with positive potential (Gene A, Animal N) and source database elements 62 are occupied with negative potential (Animal M) wherein source database elements which are not of interest for the selected search by the user or are not to be included are occupied with negative potential. Furthermore FIG. 9 shows notes regarding the individual links, which can describe and provide reasons for the cause for the link as well as the strength of the weight of the respective link in an exemplary manner.

Therefore users can—through entry of one or more search strings and also through selection of specific source database elements and by providing them with positive or negative potential—specifically follow new ideas or generate the same. Therefore the input device, such as a computer mouse, together with the output device, such as a computer monitor, represents an interactive user interface with which the user can modify the source data elements and/or the associative links and explore the output.

As already described above, the links can be formed automatically or by means of manual specification. Manual specification may, for instance, include the addition of notes by a user and/or insertion of expert knowledge into the network and is therefore largely the object of an interface such as the input device 12. The automatic addition or alteration of links may be performed in a large variety of ways:
Semantic links can be created. Semantic links are strong links, commonly with a weight value approximately equal to 1.0, which are derived from known structures such as ontology's or semantic networks. Semantic links are commonly created by experts. Semantic networks which can be automatically or semi-automatically extracted from data must add a component which can calculate the reliability of each link and convert it into a weight.
Syntactic links are links which are generated based on a surface analysis of the data. An example of this could be a text parser which converts words into word stems, eliminates compound words and generates a quantity of bi or tri-grams from this. Bigrams in the sense of the invention are likelihoods of the occurrence of word pairs. Trigrams correspond to word triples. The respective objects in a system in accordance with the invention are linked by weak links. Hypothetical links can be created by a user who creates links on the basis of hypotheses or assumptions. The weights for such links are regularly low. These links represent a contradiction with notes by experts which regularly show very high weights.
Data supported links generally include a large majority of network weights.
Data supported links can be automatically generated from data sources. An example of this may consist of the following:—
   gene correlations which are derived from gene expression data. Links are introduced when a specific threshold parameter or a multiple occurrence of experimental data is exceeded. The weight of the link reflects the correlation strength which is, for instance, defined in the following form:

$${w}_{ij} = \frac{\vert \{ \vec{x} \text{:} {g}_{i} ( \vec{x} ) \geq θ ⋀ {g}_{j} ( \vec{x} ) \geq θ \} \vert}{\vert \{ \vec{x} \text{:} {g}_{i} ( \vec{x} ) \geq θ \} \vert + \vert \{ \vec{x} \text{:} {g}_{j} ( \vec{x} ) \geq θ \} \vert}$$

wherein
   |{\vec{x}:gᵢ(\vec{x})≧θ̂gⱼ(\vec{x})≧θ}| describes the frequency of simultaneous occurrence of gene gᵢ, and gene gⱼ, in an experiment \vec{x}, wherein the frequency of gene gᵢ, and gene gⱼ are respectively larger than a threshold parameter θ,
   |{\vec{x}:gᵢ(\vec{x})≧θ}| describes the frequency of sole occurrence of gene gᵢ, in an experiment \vec{x}, wherein the frequency of gene gᵢ is respectively larger than a threshold parameter θ.
   |{\vec{x}:gⱼ(\vec{x})≧θ}| describes the frequency of sole occurrence of gene gⱼ, in an experiment \vec{x}, wherein the frequency of gene gⱼ is respectively larger than a threshold parameter θ.
In more than two dimensional correlations, the respective multi-corners are inserted. Additionally each of these links may have a comment which refers to the information source or the reason for the weight. In this example a link may refer to the experimental data and metainformation (threshold parameter Θ, data analysis, references to the precise calculation of weights);
may be a text analysis, wherein multiple occurrence of stated objects at specific intervals, corresponding to the words in between, results in a low link. The weight depends on the distance between the words/the quality of the text.
may be links between gene and protein names. Links between gene and protein names can be derived from scientific articles, e.g. based on bigram analysis. Herein the likelihood of occurrence of word pairs within a sentence or paragraph is determined and converted into proportional weights. Words which frequently occur close together therefore have a stronger link to each other. Herein weights are derived from the average distance and the average frequency of occurrence in a document, wherein the course of action is analogous to a TFIDF value (term frequency/inverse document frequency) and the weight is, for instance, calculated in the following form:

$${w}_{gp} = \frac{f ( g , p )}{{f}_{D} ( g ) {f}_{D} ( p )} ,$$

wherein
f(g, p) is constituted by the frequency of joint occurrence of the gene g and the protein p in a scientific publication or text,
f_{D}(g) is the frequency of occurrence of the gene g in the total quantity of all scientific publications and/or texts of the searched data quantity, and
f_{D}(p) is the frequency of occurrence of the protein p in the total quantity of all scientific publications and/or texts of the searched data quantity.
Ontological/thesaurus links are based on an existing ontology wherein links are inserted in order to link objects which are linked to each other on the basis of an ontology. This reflects a 1:1 correspondence between a link in the ontology and a link in the network. The respective links are strong links that is the corresponding weight equals 1.0, since there is generally no doubt about the reliability of the information. On the other hand this would have to be reflected in the weight of the link.

Referring to FIG. 10, an exemplary system for the implementation of the invention is described. An exemplary system includes a universal computing unit in the form of a common computer environment 120 such as a personal computer (PC) 120 with a processor unit 122, a system memory 124 and a system bus 126 which connects a large variety of system components, among others the system memory 124 and the processor unit 122. The processor unit 122 may perform arithmetic, logical and/or control operations by accessing the system memory 124. The system memory 124 can save information and/or instructions for use in combination with the processor unit 122. The system memory 124 may include temporary and non-temporary memories such as random access memory (RAM) 128 and read-only memory (ROM) 130. A basic input-output system (BIOS) which contains the fundamental routines that help to transfer information between the elements within the PC 120, for instance during start-up, can be stored in the ROM 130. The system bus 126 may be one of many bus structures, among others a memory bus or memory controller, a peripheral bus and a local bus which utilizes specific bus architecture from a large variety of bus architectures.

The PC 120 may furthermore posses a hard disk drive 132 for reading or writing to a hard drive (not shown) and an external disk drive 134 for reading or writing to a removable disk 136 or a removable data carrier. The removable disk may be a magnetic disk or a magnetic diskette for a magnetic disk drive or diskette drive or an optical disk such as a CD-ROM for an optical disk drive. The hard disk drive 132 and the external disk drive 134 are respectively connected to the system bus 126 via a hard disk drive interface 138 and an external disk drive interface 140. The drives and the assigned computer readable media provide non-temporary memory for computer readable instructions, data structures, program modules and other data for the PC 120. The data structures may contain the relevant data for the implementation of a process as described above. Even though the exemplary described environment uses a hard disk (not shown) and an external disk 142, it is evident to the expert that other types of computer readable media which can save computer accessible data can be used in the exemplary embodiment, such as magnetic cassettes, flash memory cards, digital video diskettes, random access memory, read-only memory, etc.

A large variety of program modules, particularly an operating system (not shown), one or more application programs 144, or program modules (not shown) and program data 146 can be saved on the hard disk, the external disk 142, the ROM 130 or the RAM 128. The application programs may include at least a part of the functionality as shown in FIG. 10.

A user can enter commands and information as described above into the PC 120 using input devices such as a keypad or keyboard 148 and a computer mouse 150. Other input devices (not shown) may include a microphone and/or other sensors, a joystick, a game pad or -cushion, a scanner or similar items. These or other input devices can be connected to the processor unit 122 using a serial interface 152 which is linked to the system 126 or can be connected by means of other interfaces such as a parallel interface 154, a game port or a universal serial bus (USB). Furthermore information can be printed with a printer 156. The printer 156 and other parallel input/output devices may be connected to the processor unit 122 by means of the parallel interface 154. A monitor 158 or other types of display device(s) are connected to the system bus 126 by means of an interface such as a video input/output 160. In addition to the monitor, the computer environment 120 may include other peripheral output devices (not shown) such as loudspeakers or acoustic outputs.

The computer environment 120 can communicate with other electronic devices such as a computer, a corded telephone, a cordless telephone, a personal digital assistant (PDA), a television or similar devices. In order to communicate, the computer environment 120 can work in a networked environment wherein connections to one or more electronic devices are utilized. FIG. 10 represents the computer environment which is networked with a remote computer or distant computer 162. The remote computer 162 may consist of another computer environment such as a server, a router, a network PC, an equal or peer device or other common network nodes and may include many or all of the elements described with reference to the computer environment 120 above. The logical connections as shown in FIG. 10 include a local area network (LAN) 164 and a wide are network (WAN) 166. Such network environments are common in offices, company-wide computer networks, intranets and the internet.

If a computer environment 120 is used in a LAN network environment, the computer environment 120 may be connected with the LAN 164 by means of a network input/output 168. If the computer environment 120 is used in a WAN network environment, the computer environment 120 may include a modem 170 or other means for producing communication via the WAN 166. The modem 170 which can be internal and external in terms of the computer environment 120 is connected to the system bus 126 by means of the serial interface 152. In the network environment, program modules which are shown relatively to the computer environment 120 or segments thereof can be stored in a remote memory system which is accessible at or from a remote computer 162 or is part of the system. Furthermore other data which are relevant to the above described process or system may be present in an accessible form on or from the remote computer 162.

In particular, the process in accordance with the invention may also be distributed in a largely arbitrary manner in a grid or parallel computer or the information network, due to which the system may, for instance, also include a grid or parallel computer.

### REFERENCE SYMBOL LIST

10 System
12 Input device
14 Output device
16 Data management system
18 Reference database
20 Source database
22 Reference database element
24 Reference database element
26 Reference database element
28 Reference database element
30 Reference database element
32 Source database element
34 Source database element
36 Source database element
38 Source database element
40 Source database element
42 Link
44 Link
46 Source database element
48 Source database element
50 Source database element
52 Source database element
54 Source database element
56 Link
58 Link
60 Link
62 Source database element
64 Link
120 Computer environment
122 Processor unit
124 System memory
126 System bus
128 Random access memory (RAM)
130 Read-only memory (ROM)
132 Hard disk drive
134 Disk drive
136 Removable disk
138 Hard disk drive interface
140 Disk drive interface
142 External disk
144 Application program
146 Program data
148 Keypad
150 Computer mouse
152 Serial interface
154 Parallel interface
156 Printer
158 Monitor
160 Video input/output
162 Remote computer
164 Local area network (LAN)
166 Wide area network (WAN)
168 Network input/output

1-33. (canceled)

34. A method for computer supported processing of source data elements of a source data quantity, the method comprising:
receiving at least one query data element, the at least one query data element including a search string;
determining, with at least one hit string of the source data quantity corresponding to the search string, a weighted link for each query data element with at least one source data element, the weighted link having a weight based on at least one associative link between each query data element and the at least one source data element; and
outputting, based on a hit likelihood of each query data element with the at least one source data element as corresponding to the weight of the weighted link.

35. The method in accordance with claim 1, further comprising:
providing a reference data quantity with reference data elements; and
generating the weighted link with at least one source data element of the source data quantity for each reference data element.

36. The method in accordance with claim 2, wherein the determining a weighted link for each query data element further includes:
determining at least one reference data element that corresponds to the query data element; and
assigning the links of the at least one reference data element with the at least one source data element to the query data element.

37. The method in accordance with claim 3, wherein the reference data element is identical to the query data element.

38. The method in accordance with claim 1, wherein each source data element is assigned a supplementary data element of a supplementary data quantity.

39. The method in accordance with claim 5, wherein the supplementary data element is provided in the output of each source data element.

40. The method in accordance with claim 1, wherein at least two query data elements are received, and for each query data element, at least one source data element is determined, and the source data elements are output in accordance with the weights of their weighted links with the respective query data elements.

41. The method in accordance with claim 7, further comprising generating an associative link with each source data element from a quantity of permutations of each of several query data elements that are linked to each source data element.

42. The method in accordance with claim 1, further comprising visually displaying one or more source data elements and/or associative links.

43. The method in accordance with claim 1, where at least one source data element is predetermined, and wherein the method further includes assigning a positive or negative potential to the at least one predetermined source data element.

44. The method in accordance with claim 10, wherein predetermination of the at least one source data element and the assigning of the positive or negative potential to the at least one predetermined source data element is manually performed by a user.

45. The method in accordance with claim 11, wherein predetermination of the at least one source data element and the assigning of the positive or negative potential by the user is performed before receiving the at least one query data element.

46. The method in accordance with claim 1, wherein determining the weighted link for each query data element further comprises:
determining a first source data element for each query data element;
determining a weighted link with a further source data element for each first source data element;
wherein each first source data element is defined as a query data element, and each further source data element is defined as a first source data element.

47. The method in accordance with claim 13, further comprising repeating the determining steps in two or more iterations.

48. The method in accordance with claim 13, wherein each first source data element is output in accordance with the weight of an associated weighted link.

49. The method in accordance with claim 1, wherein the source data quantity is expandable.

50. The method in accordance with claim 16, wherein additional source data elements and/or additional reference data elements of the reference data quantity are added and weighted links are generated between the additional source data elements and the corresponding additional reference data elements.

51. The method in accordance with claim 17, wherein weighted links are generated between the additional source data elements and existing reference data elements, and weighted links are generated between the additional reference data elements and existing source data elements.

52. The method in accordance with claim 1, wherein a weight wᵢⱼ of the weighted link between a reference data element Rᵢ and a source data element Qⱼ is calculated from the frequency of the occurrence of the reference data element Rᵢ and the source data element Qⱼ respectively in a supplementary data element as follows:
$${w}_{ij} = \frac{f ( {R}_{i} , {Q}_{j} )}{{f}_{Q} ( {R}_{i} ) {f}_{Q} ( {Q}_{j} )} ,$$
wherein:
f(Rᵢ, Qⱼ) represents the frequency of the joint occurrence of the reference data element Rᵢ and the source data element Qⱼ in the supplementary data element;
f_{Q}(Rᵢ) represents the frequency of occurrence of the reference data element Rᵢ in the total quantity of all supplementary data elements; and
f_{Q}(Qⱼ) represents the frequency of the occurrence of the source data element Qⱼ in the total quantity of all supplementary data elements.

53. The method in accordance with claim 1, wherein a weight wᵢⱼ of the weighted link between a reference data element Rᵢ and a source data element Qⱼ is calculated as follows:
$${w}_{ij} = \frac{\vert \{ \vec{x} \text{:} {R}_{i} ( \vec{x} ) \geq θ ⋀ {Q}_{j} ( \vec{x} ) \geq θ \} \vert}{\vert \{ \vec{x} \text{:} {R}_{i} ( \vec{x} ) \geq θ \} \vert + \vert \{ \vec{x} \text{:} {Q}_{j} ( \vec{x} ) \geq θ \} \vert}$$
wherein:

|{\vec{x}:Rᵢ(\vec{x})≧θ̂Qⱼ(\vec{x})≧θ}| represents the frequency of simultaneous occurrence of the reference data element Rᵢ, for instance a gene A, and the source data element Qⱼ, for instance a gene B, in an experiment \vec{x}, wherein the frequency of the reference data element Rᵢ and the source data element Qⱼ is respectively larger than a threshold parameter θ;

|{\vec{x}:Rᵢ(\vec{x})≧θ}| represents the frequency of sole occurrence of the reference data element Rᵢ, in an experiment x, wherein the frequency of the reference data element Rᵢ is greater than a threshold parameter θ; and

|{\vec{x}:Qⱼ(\vec{x})≧θ}| represents the frequency of sole occurrence of the source data element Qⱼ, in an experiment \vec{x}, wherein the frequency of the source data element Qⱼ is greater than a threshold parameter θ.

54. A method for computer supported processing of source data elements of a source data quantity, the method comprising:
receiving a plurality of query data elements, each query data element having at least one search string;
determining, with at least one hit string of the source data quantity corresponding to the search string, a joint weighted link for the plurality of query data elements with at least one source data element, the joint weighted link having a weight based on two or more associative links between the plurality of query data elements and the at least one source data element; and
outputting, based on a hit likelihood of the plurality of query data elements with the at least one source data element as corresponding to the weight of the joint weighted link.

55. A system for processing source data elements of a source data quantity, the system comprising:
an input device configured to receive at least one query data element, the at least one query data element including a search string;
a microprocessor device configured to determine, with at least one hit string of the source data quantity corresponding to the search string, a weighted link for each query data element with at least one source data element, the weighted link having a weight based on at least one associative link between each query data element and the at least one source data element; and
an output device configured to output, based on a hit likelihood of each query data element with the at least one source data element as corresponding to the weight of the weighted link.

56. The system in accordance with claim 22, further comprising a reference database with reference database elements, and wherein the microprocessor device is further configured to generate a weighted link with at least one source database element of the source database for each reference database element.

57. The system in accordance with claim 23, wherein the microprocessor device is further configured, during determining the links of the query data element with the at least one source database element, to determine at least one reference database element that corresponds to the query data element, and to assign the links of the at least one reference database element with the at least one source database element to the query data element.

58. The system in accordance with claim 24, further comprising a supplementary database having a supplementary database element that is assigned to each source database element.

59. The system in accordance with claim 25, wherein the output device is configured to provide the supplementary database element at the output of each source database element.

60. The system in accordance with claim 25, wherein the source database is expandable with additional source database elements, and the supplementary database is expandable with additional supplementary database elements.

61. The system in accordance with claim 27, wherein the microprocessor device is further configured to generate additional reference database elements with the additional source database elements and/or the additional supplementary database elements, and to generate weighted links between the additional source database elements and the corresponding reference database elements.

62. The system in accordance with claims 22, wherein the output device is configured to visually display one or more source data elements and/or associative link.

63. The system in accordance with claim 22, wherein the input device is further configured to predetermine at least one source data element, and to assign a positive or negative potential to the at least one source data element.

64. The system in accordance with claim 30, wherein the input device is configured so that the predetermination of the at least one source data element and the assignment of the positive or negative potential is manually performed by a user.

65. The system in accordance with claim 31, wherein the input device is configured so that the predetermination of the at least one source data element and the assignment of the positive or negative potential by the user can be performed before receiving the at least one query data element.

66. A computer program product which, when loaded into the memory of a data management system such as a computer, causes the data processing system to perform a process comprising steps to:
receive at least one query data element, the at least one query data element including a search string;
determine, with at least one hit string of the source data quantity corresponding to the search string, a weighted link for each query data element with at least one source data element, the weighted link having a weight based on at least one associative link between each query data element and the at least one source data element; and
output, based on a hit likelihood of each query data element with the at least one source data element as corresponding to the weight of the weighted link.
